(19) United States
(12) Patent Application Publication
(10) Pub. No.: US 2009/0247186 A1
(43) Pub. Date: Oct. 1, 2009

(54) Dynamic Localization Using Geographical Information Systems

(75) Inventors: Yiming Ji, Guyton, GA (US); Gordon D. Sproul, Beaufort, SC (US)

Correspondence Address: DORITY & MANNING, P.A., POST OFFICE BOX 1449, GREENVILLE, SC, 29602-1449, US

(73) Assignee: University of South Carolina, Columbia, SC (US)

(21) Appl. No.: 12/407,343

(22) Filed: Mar. 19, 2009

Related U.S. Application Data
(60) Provisional application No. 61/072,253, filed on Mar. 28, 2008.

(51) Int. Cl. H04W 4/02

(52) U.S. Cl. 455/456.1

(57) ABSTRACT

In accordance with certain embodiments of the present disclosure, a system to determine the geographic location of a mobile device is described. The system comprises a mobile device. The mobile device comprises a measurement module, the measurement module being capable of detecting information including the direction and acceleration of the mobile device, the mobile device further being capable of determining the received signal strength from at least one access point. The system further comprises at least one access point being in communication with the mobile device. The at least one access point comprises a database module and a location determination module, the database module including data from a geographic information system, the data relating to the potential geographic locations adjacent to the at least one access point, the location determination module being capable of determining the geographic location of the mobile device based on information from the measurement module, received signal strength by the mobile device, and data from the database module.

### CROSS-REFERENCE TO RELATED APPLICATION

The present application is based on and claims priority to U.S. Provisional Application Ser. No. 61/072,253 having a filing date of Mar. 20, 2008, which is incorporated by reference herein.

### FIELD OF INVENTION

The present disclosure is directed toward the use of a mathematical methodology to dynamically determine the geographic location of a mobile user in the outdoor environment. The purpose is to facilitate navigation, traffic control, emergency, business, and many other services that are supported by location information by a mobile user. The present disclosure contemplates a distributed system that allows Access Points (APs) or cellular towers to determine a mobile device's location using only the received signal strength from a mobile user and the mobile device's mobility information (i.e., moving direction, velocity or traveled distance).

A system of the present disclosure is deployable with most wireless networks that transmit stable beacons from APs or cellular towers such as Wi-Fi and GSM networks. Beacon signals usually carry critical parameters such as power-supply information, time stamp, signal strength, and available bandwidth resources, which would be important for the mobile devices in order to synchronize and coordinate with the AP or the cellular towers.

### BACKGROUND

There are many location systems that have been developed or are currently being evaluated. In general, most localization determination systems are based on the following four methods: (1) time of arrival (TOA) or time difference of arrival (TDOA); (2) angle of arrival (AOA); (3) received signal strength indicator (RSSI); and (4) network connectivity based ranging method.

Time of arrival (TOA) measures the traveling time of radio signals, and time difference of arrival (TDOA) measures the time difference of the radio signals arriving at various antennas. Both TOA and TDOA are the most common methods used for the range estimation. They have been applied in many localization systems and are the subject of a number of issued patents such as U.S. Pat. Nos. 6,119,013 and 6,108,555, both to Maloney et al. and both entitled “Enhanced time-difference localization system”, both of which are incorporated by reference herein. However, these time-based methods require time synchronization among network base stations; in addition, these methods require at least three base stations in order to pinpoint a mobile.

The satellite-based Global Positioning System (GPS) is a representative TOA based localization system. The GPS system consists of 24 orbiting operational satellites, which can transmit very low power radio signals that allow any GPS receiver to determine its position on Earth. In order to determine its location, the GPS receiver generally requires a clear view of the sky which limits its usage indoors or under obstructions such as trees. GPS also works poorly in big cities where tall buildings prevent the Line of Sight path to satellites. Additionally, the operating cost of the GPS tracking is very high. As a result, a group of New York taxi drivers launched a 48-hour strike on Sep. 5, 2007 against the requirement of the GPS tracking system by the Taxi & Limousine Commission.

Another localization method, Angle of Arrival (AOA), uses triangulation of angles between the mobile and neighboring cell towers. This method has been addressed in U.S. Pat. No. 5,959,580 to Maloney et al. entitled “Communications localization system” and U.S. Pat. No. 4,728,959 to Maloney et al. entitled “Direction finding localization system”, both of which are incorporated by reference herein. The AOA method requires directional antennas or antenna arrays for proper operation which is expensive to implement and maintain.

The E911 initiative in US (E211 in Europe) required cellular providers to be able to locate a mobile in emergency within 150 meters by Dec. 31, 2005. The current localization technique generally uses either a hybrid network-client method like the assisted GPS (A-GPS) system or network-only techniques like TOA/TDOA, AOA, or a combination of them. A-GPS works by integrating the classic GPS information with sophisticated geographic software and mobile/cellular network information. A-GPS extends the operation of traditional GPS to indoor environments, and still provides reasonable localization performance. Several wireless phone companies have deployed location-based services using cell phones.

Recently, received signal strength indicator (RSSI), has been widely used in many localization systems. Most RSSI based systems require a complex offline phase where a radio map of the interested area must be constructed. The radio map contains received signal strength values at a grid of locations from all nearby APs. In general, most systems construct the radio map by manual measurements. For example the research of Chen et al., “Practical Metropolitan-Scale Positioning for GSM Phones,” in Proceedings of Ubicomp, 2006, used 208 hours to collect data in a 4350 m trace covering the Seattle metropolitan area. Such a tedious data collection process is static in nature without considering such dynamic effects as weather and other environment factors; therefore, radio map based method using RSSI is not feasible for large projects.

The present disclosure, based on integrated Geographical Information Systems (GIS), has the advantages of having a low barrier to entry for users with commodity devices like laptops, PDAs, cell phones, and the like that can integrate with commercial sensors like digital compass and accelerometers; and it is readily deployable to any networks that transmit stable beacons from APs or cellular towers without infrastructure modification or tedious data collections. With integrated GIS resources, the systems of the present disclosure do not require dense tower deployment in order to estimate a mobile's location.

### SUMMARY

In accordance with certain embodiments of the present disclosure, a system to determine the geographic location of a mobile device is described. The system comprises a mobile device. The mobile device comprises a measurement module, the measurement module being capable of detecting information including the direction and acceleration of the mobile device, the mobile device further being capable of determining the received signal strength from at least one access point. The system further comprises at least one access point being in communication with the mobile device. The at least one access point comprises a database module and a location determination module, the database module including data from a geographic information system, the data relating to the potential geographic locations adjacent to the at least one access point, the location determination module being capable of determining the geographic location of the mobile device based on information from the measurement module, received signal strength by the mobile device, and data from the database module.

In addition, in certain embodiments of the present disclosure, a method to determine the geographic location of a mobile device is provided.

### BRIEF DESCRIPTION OF THE DRAWINGS

A full and enabling disclosure, including the best mode thereof, directed to one of ordinary skill in the art, is set forth more particularly in the remainder of the specification, which makes reference to the appended figures in which:

FIG. 1 illustrates a coordination system and direction notations used in accordance with certain embodiments of the present disclosure;

FIG. 2 illustrates basic location determination scenarios when a mobile user is communicating with an AP or a cellular tower in accordance with certain embodiments of the present disclosure;

FIG. 3 presents architecture and functional components in accordance with certain embodiments of the present disclosure;

FIG. 4 indicates a detailed structure of the database components in accordance with certain embodiments of the present disclosure;

FIG. 5 illustrates a basic cellular architecture in accordance with certain embodiments of the present disclosure;

FIG. 6 illustrates a potential ambiguous scenario in location determination in accordance with certain embodiments of the present disclosure;

FIG. 7 illustrates a general procedure in location determination in accordance with certain embodiments of the present disclosure;

FIG. 8 illustrates a scenario when a mobile user is moving on a curved road in accordance with certain embodiments of the present disclosure;

FIG. 9 illustrates a test-bed that was used in a system evaluation in accordance with certain embodiments of the present disclosure;

FIG. 10 illustrates a test-bed in a residential neighborhood in accordance with certain embodiments of the present disclosure;

FIG. 11 illustrates measurements in different environments;

FIG. 12 illustrates accelerometer calibration; and

FIG. 13 illustrates road modeling at different resolutions.

### DETAILED DESCRIPTION OF INVENTION

Reference now will be made in detail to various embodiments of the disclosure, one or more examples of which are set forth below. Each example is provided by way of explanation of the disclosure, not limitation of the disclosure. In fact, it will be apparent to those skilled in the art that various modifications and variations can be made in the present disclosure without departing from the scope or spirit of the disclosure. For instance, features illustrated or described as part of one embodiment, can be used on another embodiment to yield a still further embodiment. Thus, it is intended that the present disclosure covers such modifications and variations as come within the scope of the appended claims and their equivalents.

The systems and methods discussed herein can be implemented using servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes can be implemented using a single server or multiple servers working in combination. Databases and applications can be implemented on a single system or distributed across multiple systems. Distributed components can operate sequentially or in parallel.

When data is obtained or accessed between a first and second computer system or component thereof, the actual data can travel between the systems directly or indirectly. For example, if a first computer accesses a file or data from a second computer, the access can involve one or more intermediary computers, proxies, and the like. The actual file or data can move between the computers, or one computer can provide a pointer or metafile that the second computer uses to access the actual data from a computer other than the first computer, for instance.

The various computer systems that can be utilized with the present disclosure are not limited to any particular hardware architecture or configuration. Embodiments of the methods and systems set forth herein can be implemented by one or more general-purpose or customized computing devices adapted in any suitable manner to provide desired functionality. The device(s) can be adapted to provide additional functionality complementary or unrelated to the present subject matter, as well. For instance, one or more computing devices can be adapted to provide desired functionality by accessing software instructions rendered in a computer-readable form. When software is used, any suitable programming, scripting, or other type of language or combinations of languages can be used to implement the teachings contained herein. However, software need not be used exclusively, or at all. For example, some embodiments of the methods and systems set forth herein can also be implemented by hard-wired logic or other circuitry, including, but not limited to application-specific circuits. Of course, combinations of computer-executed software and hard-wired logic or other circuitry can be suitable, as well.

Embodiments of the methods disclosed herein can be executed by one or more suitable computing devices. Such system(s) can comprise one or more computing devices adapted to perform one or more embodiments of the methods disclosed herein. As noted above, such devices can access one or more computer-readable media that embody computer-readable instructions which, when executed by at least one computer, cause the at least one computer to implement one or more embodiments of the methods of the present subject matter. Additionally or alternatively, the computing device(s) can comprise circuitry that renders the device(s) operative to implement one or more of the methods of the present subject matter.

Any suitable computer-readable medium or media can be used to implement or practice the presently-disclosed subject matter, including, but not limited to, diskettes, drives, and other magnetic-based storage media, optical storage media, including disks (including CD-ROMS, DVD-ROMS, and variants thereof), flash, and other memory devices, and the like.

The present disclosure also can also utilize a relay of communicated data over one or more communications networks. It should be appreciated that network communications can comprise sending and/or receiving information over one or more networks of various forms. For example, a network can comprise a dial-in network, a local area network (LAN), wide area network (WAN), public switched telephone network (PSTN), the Internet, intranet or other type(s) of networks. A network can comprise any number and/or combination of hard-wired, wireless, or other communication links.

The present disclosure provides a dynamic outdoor localization system that is able to be used by any network that transmits stable beacons from APs or cellular towers. As used herein, the term “AP” will be used to designate either APs or cellular towers. The system described herein exploits the mobile's location using three modules: a Measurement Module, a Database Module, and a Location Determination Module. The Measurement Module allows the mobile to collect its motion direction (using a digital compass) and the velocity & distance (using an accelerometer); the Database Module includes road geometries (directions and longitude/latitude coordinates) and location attributes (like road names, speed limits, post code, and nearby attractions) that are derived from GIS systems; and the Location Determination Module enables associated APs or cellular towers to automatically determine the mobile's location using the received signal strength.

The present disclosure does not require extensive manual data measurement, data calibration or other preprocessing, nor does it require the pre-construction of signal strength map tables. The present disclosure is an outdoor localization system that serves as a complement (or a backup) for a GPS system and it targets intelligent transportation applications such as traffic control, road tolling, fleet management, and location-sensitive advertising. The present disclosure does not build a radio strength table that maps locations; instead, it works by allowing the mobile to continuously monitor the signal strength (SSi) of received beacons at an unknown location i from the AP or cellular tower. If it is assumed that the mobile knows its moving direction (αᵢ) and is also able to measure the traveling distance (dᵢⱼ) between the current position i and its previous measurement position j, then from communication, the AP would be able to get a serial of triplets of (SSᵢ, αᵢ, dᵢⱼ) for the mobile. If the mobile is moving on a straight path, then with only three discrete measurements, the present disclosure would be able to determine the relative position of the mobile to the associated AP. With the assistance of a second nearby AP, the mobile's position would be uniquely determined. With the assistance of the GIS at the AP, a mobile that travels on any road would be located using the systems and methods of the present disclosure. Therefore, the present disclosure describes systems that are dynamic and not constrained by the operation environment. By integrating with GIS resources, the systems of the present disclosure do not require dense tower deployment in order to pinpoint a mobile's location.

A prototype of a system in accordance with the present disclosure was evaluated using two IEEE 802.11 networks at both the University of South Carolina Beaufort and in a residential neighborhood in Columbia, S.C. In addition, this system was also evaluated using online data from the war-driving community and other research groups. Results indicate that the present disclosure provides reliable localization performance.

The deployment of the present disclosure would support a mobile's navigation with actual address or nearby attractions in addition to the physical coordinates like longitude and latitude. With existing cellular networks, as well as future deployment of Mesh, WiMAX, and Mobile-Fi networks, the present disclosure would be useful in the development of various projects towards intelligent transportation systems, such as electronic toll collection, real-time adaptive traffic signals, intelligent surveillance systems, incident detection and response systems, and multi-modal traveler information systems to improve overall traffic operations and reduce congestion.

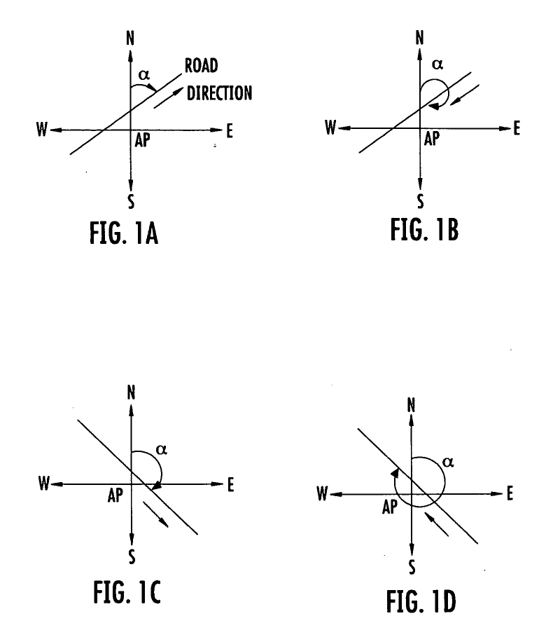

The present disclosure introduces the relative coordinate system between an AP and a mobile. As illustrated in FIG. 1, the AP is the origin of the coordinate system, and the mobile is moving along a straight path close to the AP. Let α denote the direction of motion of the mobile user (the azimuth reading from the digital compass); thus if two mobiles are moving in the same straight path in opposite directions, the azimuth readings will be different by 180 degrees (FIG. 1(a) [symbol] (b), and (c) [symbol] (d)). Let d₀ denote the shortest distance from the AP to the route of the mobile.

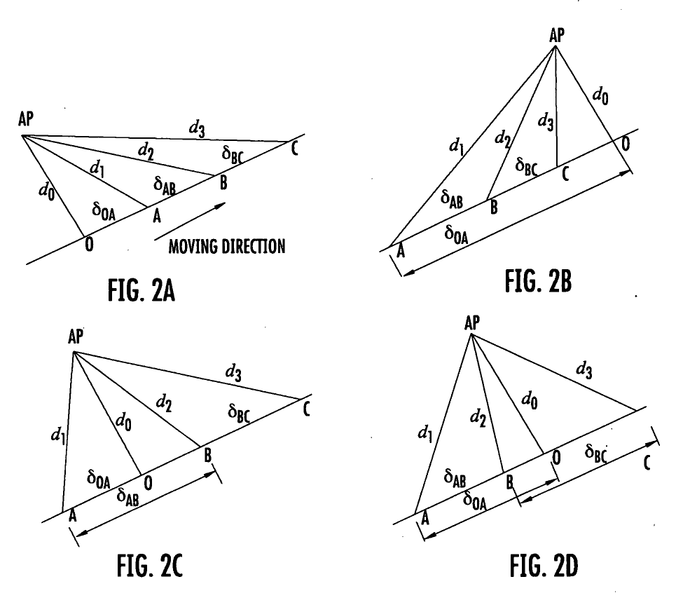

If a mobile is moving on a route from southwest to northeast, it records the received signal strength from the AP continuously at multiple locations (for example A, B, C) as shown in FIG. 2; here dᵢ (i=1, 2, 3) is used to denote the distance from the AP to the three locations. In FIG. 2, δ_{OA} is used to represent the distance between the starting location A and the AP projection point 0, and δ_{AB} and δ_{BC} represent the distance between successive sampling positions.

FIG. 2 illustrates four typical scenarios for the relative locations between the AP and the mobile. FIGS. (a) and (b) denote the situations when the mobile monotonically approaches or moves away from the AP; and FIGS. (c) and (d) present two slightly more complex cases where the mobile is passing by the AP. FIG. 2 is discussed in more detail herein.

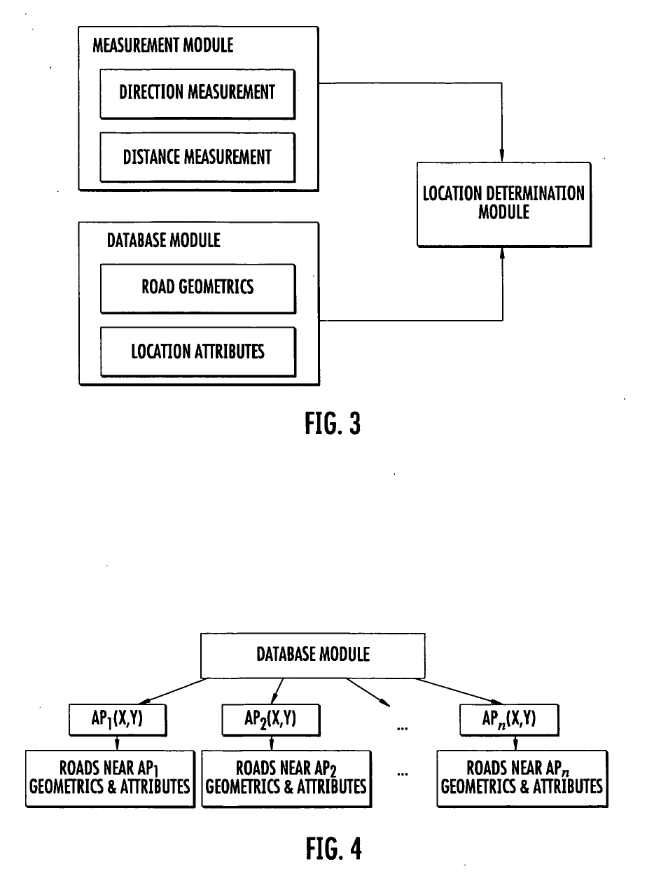

In accordance with certain embodiments of the present disclosure, the localization system described herein can contain three modules: a Measurement Module, a Database Module, and a Location Determination Module. As illustrated in FIG. 3, the Measurement Module can further include two components: the direction measurement and the distance measurement. The Database Module can also include two components: the road geometries and the location attributes.

### Measurement Module

The Measurement Module can record the mobile's moving characteristics, which include direction, speed, acceleration, or the traveled distance. Such measurements can be accomplished at the mobile by a digital compass and an accelerometer.

A compass is a navigational instrument for finding directions. An early form of compass was invented in China in the 11th century. The familiar mariner's compass was invented in Europe around 1300. The traditional compass uses a magnetic needle to indicate the direction of the magnetic north of the planet's magnetosphere. The latest digital magnetic compass uses a new azimuth sensor that achieves an azimuth accuracy of 0.5 degree with 0.1 degree resolution. Suitable digital compasses are known in the art and one such digital compass is manufactured by Honeywell Technology. Currently, digital compasses are widely used by many mobile devices; for example, the Nokia 5140 phone contains a digital compass, and thus it allows the mobile user to obtain its orientation.

An accelerometer is a device for measuring acceleration. An accelerometer inherently measures its own motion, in contrast to a device based on remote sensing. Most basic accelerometers consist of a proof mass and a spring-like joint that attaches the mass to the rest of the sensor, and they are usually referred to as the pendulous accelerometers. With the development of micro-electromechanical systems (MEMS) technology, it is common to embed micro acceleration sensors (accelerometers) into other commercial products. For example, Nike, Polar and other companies have produced and marketed sports watches for runners that include footpads, which contain accelerometers to help determine the speed and distance for the runner wearing the unit. Similarly, VTI Technologies apply accelerometers in hand-held sports and wellness applications by measuring working speed, distance traveled and energy consumed during exercise. In addition, researchers have also been working on low cost distance measuring mechanisms using accelerometers.

Velocity and distance traveled can be determined by using derivations of the following equations:

$$\{ \begin{matrix}{V}_{final} = {V}_{initial} + Acceleration \times Time \\ Distance = \frac{1}{2} \times ( {V}_{final} + {V}_{initial} ) \times Time\end{matrix} \qquad ( 1 )$$

where V_{final} and Vᵢₙᵢₜᵢₐₗ represent the starting and ending velocity; Acceleration is the longitudinal acceleration, and Time is the traveling time period when the mobile travels at the Acceleration.

In reality, the acceleration changes over time, therefore, a practical method would be first to monitor the reading from the accelerometer; at each stable accelerating period (before the next change), Equation (1) can be utilized to determine the velocity and traveling distance. Consequently, for realistic travel including changes in direction and speed, a sequence of discrete velocities and distances (i.e., [Vᵢ, Distanceᵢ], (i=1, 2, . . . , n)) could be recorded. The total traveling distance between different measurement points could be determined by the sum of all discrete distance pieces; and the maximum traveling speed would also be determined:

$$\begin{matrix}Distance = {\sum }_{i = 1}^{n} {Distance}_{i} & ( 1 a ) \\ {V}_{Max} = {max}_{i = 1}^{n} {V}_{i} & ( 1 b )\end{matrix}$$

### Database Module

The Database Module can record the road geometries (i.e., longitude/latitude coordinates, directions) and location attributes like road names, speed limits, post code, and nearby attractions) from Geographic Information Systems (GIS). A GIS is a database system designed to work with data referenced by spatial or geographical coordinates on the earth. There are two primary types of data in GIS: raster and vector. In the raster data type, real world data is expressed as a matrix of cells or pixels with spatial position implicit in the ordering of the pixels. This means that spatial data is not continuous but divided into discrete units. Generally, raster data requires more storage space since it saves both the “empty” space and the real entities. On the other hand, in the vector data, geospatial topology is stored explicitly, and special units are represented by points, lines (arcs) and polygons using coordinates. For example, a particular location can be referenced by its coordinates; a line (a road) is determined by a collection of adjacent point coordinates and a polygon (an area) is a collection of connected lines. This makes vector data particularly suitable for the systems described herein. While vector data is particularly suitable for the systems described herein, this does not preclude the possibility of the use of raster data.

The Database Module records road geometrics and corresponding location attributes in order to assist the location determination and to provide meaningful social information associated with a user's location. The overall structure of the Database Module is given in FIG. 4. In this system, each AP (or cellular tower) collects the location attributes and coordinates for all roads inside its coverage area. Then the collection of road information at all APs (or all cellular towers) would compose a complete Database Module for the system.

FIG. 5 provides examples of three neighboring AP cells (A, B, and C) along a road. In the figure, cell A, B, and C roughly cover the road sections of i-ii, ii-iii, and iii-iv, respectively; the mobile is currently associated with the cell tower A (denoted by the dash dotted line). The dotted line in the figure means that the signal from the mobile could also be monitored by the neighboring cell tower B (for the handoff process). Therefore, it is reasonable for the AP to collect and record, in advance, coordinates of the road within its coverage space (i.e., coordinates of i, ii, iii, and iv in the figure). For each road section (for example, section i-ii), the AP of the covering cell (i.e., cell A) would collect the location attributes and coordinates at all transition points, and build detailed database records for the road. Similarly, the AP could put together the information of all roads within its coverage area. Table I shows an example database at an AP. In the table, ‘Attributes’ could include orientation of the road section (α), distance from AP to the road (d₀), maximum speed (V_{Max}), as well as other information such as road names and nearby attractions. The collection of road information at all APs can compose a complete Database Module for the systems of the present disclosure.

Using the systems described herein, the location of a mobile is first confined to an AP cell that provides the wireless communication service (FIG. 5). Then the search will be further narrowed to a finite number of roads (with different d₀) according to the mobile's moving direction α; and eventually, detailed location coordinates and attributes would be estimated using the Location Determination Module.

The amount of road information that each AP or cellular tower stores within its region is dependent upon the AP's or cellular tower's signal coverage (or the cell's horizontal radius). In general, the cell space varies depending on many factors like antenna height, antenna gain and propagation conditions in different environments like free space, rural, suburban, and urban areas. The longest distance that the Global System for Mobile communications (GSM) supports in practical use is about 35 km or about 22 miles. Assuming there are 1000 road sections in a cell, and each road requires 1 kB to record its geometric parameters and associate attributes, then each cell will only need 1 MB storage for the data information. Therefore, the storage for the system is both minimal and feasible.

### Location Determination Module

In the Location Determination Module, the associated AP or cellular tower determines the mobile's location using the mobile's mobility information from the Measurement Module and the constraints from the Database Module. Through communication, the mobile informs the AP or cellular tower of its moving direction, velocity, and traveling distance. The AP or cellular tower then searches database records of roads according to the direction and speed limits, and calculates the location of the mobile using the signal strength according to the formulas discussed herein.

A single AP may not be able to discriminate the route of the mobile on two or more comparable roads; consequently, the localization of the mobile may need the assistance of additional nearby APs. In reality, APs in both urban and suburban areas are relatively dense and easily accessible. Therefore, it is reasonable that multiple APs would monitor the targeted mobile (for purposes like the handoff process) and provide the signal information to the associated AP for localization.

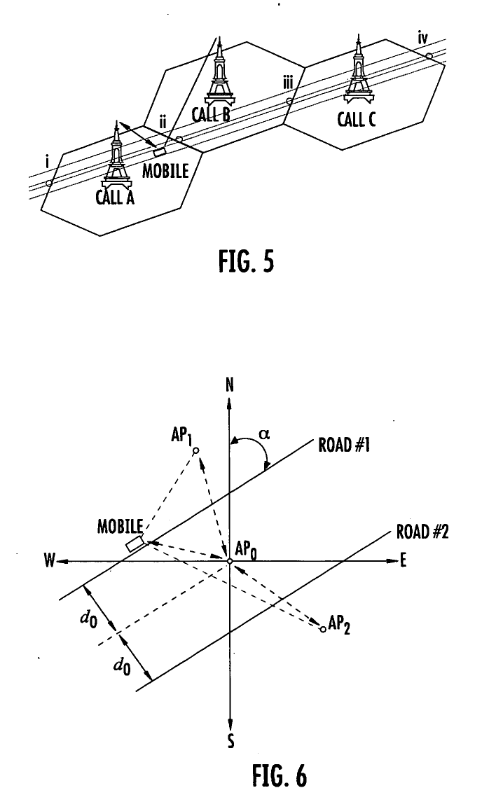

FIG. 6 illustrates this scenario. In the figure, three APs (AP₀, AP₁, and AP₂) are located along the two roads #1 and #2 of the same orientation. The mobile is assumed to move on the road #1, and is currently associated with the AP₀ (denoted by the dash dotted line). The dash dotted lines are also used to denote the communication links between the APs (AP₀-AP₁ and AP₀-AP₂). The dotted lines between the mobile and the APᵢ (i=1, 2) indicate that the mobile is also monitored by AP₁ and AP₂ (without direct communication to the mobile). Using only the motion direction would result in two different roads from the Database Module. Two solutions for this problem have been determined in accordance with the present disclosure.

First, if AP₁ is closer to the mobile than AP₂ and the communication environment is similar for all APs, the AP₁ would generally obtain a higher signal strength from the mobile. Therefore, through communication, AP₀ would know that the mobile is moving on the road #1.

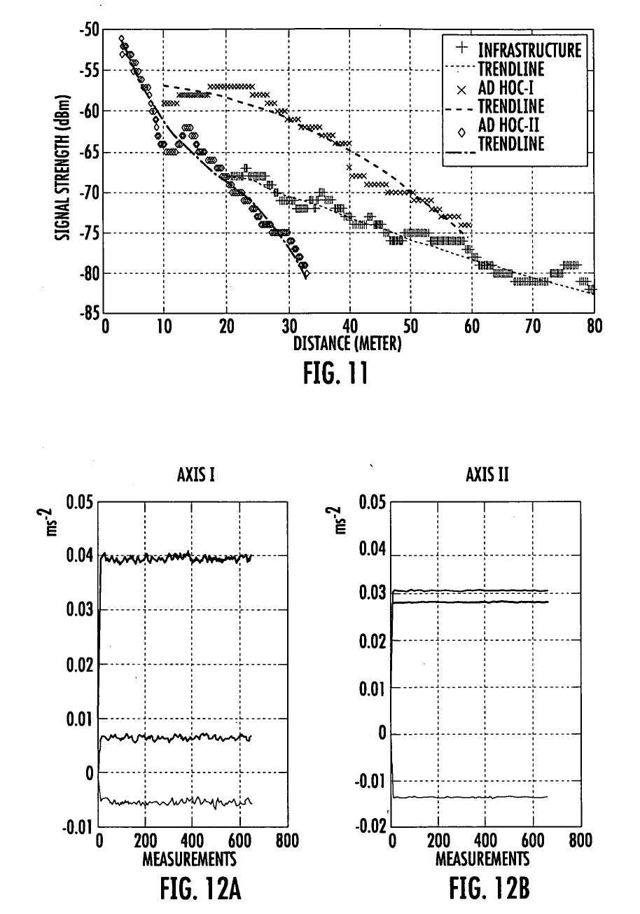

And second, if available APs are very limited (for example, in rural areas), or in other cases, if a closer distance does not result in a stronger signal strength (SS) value (as we will see in FIG. 11 described herein), the previous solution using nearby APs (if available) may not be adequate for this complex localization process. In such a case, a traceable road history can be exploited to help resolve the ambiguity. In order to build a road history, the AP can maintain a profile of the mobile's previous positions. Example profile records would include start/end locations (such as a home or office address, airport or other social locations) and unique transition/turning positions along roads. This history profile may also be used to search the location for a stationary mobile client.

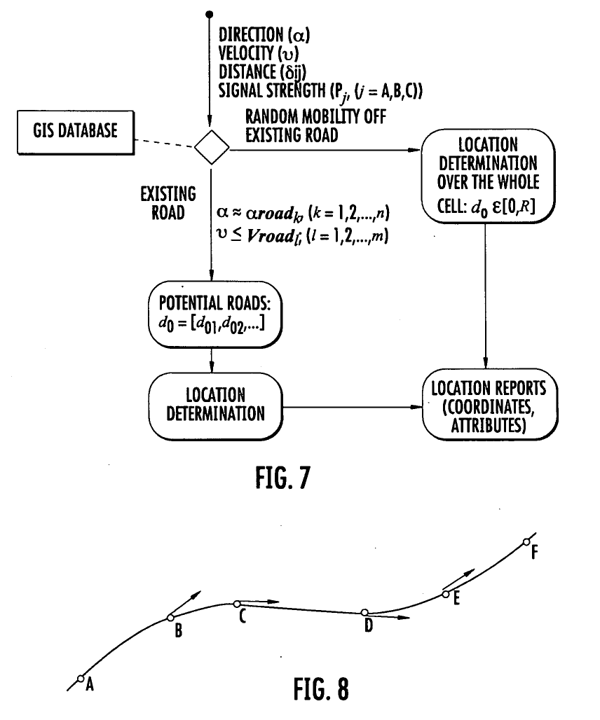

A graphical representation of the location determination procedure is given in FIG. 7. When the AP receives mobile's travel status (on or off an existing road), motion direction, velocity/acceleration or distance, and the signal strength measurements, the AP will determine its searching mechanism by either using the GIS database or extensive searching over the whole cell space. If the mobile is moving on an existing road, the AP tower would be able to identify a finite number of roads with specified direction and speed limits. Then the distances d₀ between the AP and the roads would be discovered. On the other hand, if the mobile is moving off the road, the distance d₀ would be in a much broader range, or d₀ ∈ [0, R], which increases the computation effort. Eventually, the location coordinates of the mobile would be determined and related social attributes would also be retrieved from the GIS database.

Referring again to FIG. 2, when a mobile is moving along a straight route and it reports the received signal strength from the AP at three distinct locations of A, B, and C, there exists these equations according to the Pythagorean theorem:

$$\{ \begin{matrix}{δ}_{OA}^{2} + {d}_{0}^{2} = {d}_{1}^{2} \\ {( {δ}_{OA} + {δ}_{AB} )}^{2} + {d}_{0}^{2} = {d}_{2}^{2} \\ {( {δ}_{OA} + {δ}_{AB} + {δ}_{BC} )}^{2} + {d}_{0}^{2} = {d}_{3}^{2}\end{matrix} \vert \{ \begin{matrix}{δ}_{OA}^{2} + {d}_{0}^{2} = {d}_{1}^{2} \\ {( {δ}_{OA} + y )}^{2} + {d}_{0}^{2} = {d}_{2}^{2} \\ {( {δ}_{OA} + {δ}_{AB} + {δ}_{BC} )}^{2} + {d}_{0}^{2} = {d}_{3}^{2}\end{matrix} \qquad ( 3 )$$

where the equations in the left column denote the scenario for the situation (a) in FIG. 2, and equations in the right column represent other scenarios (b, c, d) in the figure.

In order to choose a correct formula in the localization process, the signal strength records in the mobile are used. In reality, the mobile monitors the received signal strength continuously; therefore, the mobile would observe characteristics of the signals along the road. If the signal strength decreases monotonously, this means that the mobile is moving away from the AP, and thus the equations on the left column should be used.

In addition to information determined by the Pythagorean Theorem geometries, additional location relationship between the mobile and the AP or the cellular tower can be determined from the Distance Path-Loss model. The model is expressed as follows:

P=P₀−10·n·log₁₀(d) (4)

Where P is the power (in dB) at a reference distance (1 m, 1 km, or 1 mile); d is the distance between the transmitter (the AP) and the receiver (the mobile); and n is the path-loss distance exponent, which is 2 for free space. Typical values of the path-loss exponent generally range between 2.0 to 4.0 for most natural environment.

Therefore, if Pⱼ, (j=A, B, C) represent the received signal strength at location A, B, and C, three equations could be derived using the Distance Path-Loss model:

$$\{ \begin{matrix}{P}_{A} = {P}_{0} - 10 \cdot n \cdot {log}_{10} ( {d}_{1} ) \\ {P}_{B} = {P}_{0} - 10 \cdot n \cdot {log}_{10} ( {d}_{2} ) \\ {P}_{C} = {P}_{0} - 10 \cdot n \cdot {log}_{10} ( {d}_{3} )\end{matrix} \qquad ( 5 )$$

By combing Equation (3) and (5), it is possible determine the six unknowns [δ_{OA}, dᵢ(i=0,1,2,3), n] using existing values of [Pⱼ(j=0, A, B, C), δ_{AB}, δ_{BC}].

If the maximum radio transmission range of the AP is R, the distance d₀ and δ_{OA} must both be within the range from 0 to R, or {d₀,δ_{OA}} ∈ [0, R]. In most cases, the user would move on an existing road near the AP or cellular tower, in which case the distance d₀ would be an array with a finite number of values. These values would be pre-determined using the GIS system.

For each potential value for the unknowns, the system would calculate the errors (i.e. εᵢ, (i=0,1,2)) for all distances from Equation (6), and adjust the total error (ε=ε₁+ε₂+ε₃) at each searching step until it reaches the targeted precision.

$$\{ \begin{matrix}\begin{matrix}{ɛ}_{0} = {δ}_{OA}^{2} + {d}_{0}^{2} - {d}_{1}^{2} \\ {ɛ}_{1} = {( {δ}_{OA} \pm {δ}_{AB} )}^{2} + {d}_{0}^{2} - {d}_{2}^{2} \\ {ɛ}_{2} = {( {δ}_{OA} \pm {δ}_{AB} \pm {δ}_{BC} )}^{2} + {d}_{0}^{2} - {d}_{3}^{2}\end{matrix} \\ ɛ = {ɛ}_{1} + {ɛ}_{2} + {ɛ}_{3}\end{matrix} \qquad ( 6 )$$

These results assume that the mobile is moving on a straight path during the localization process, but in reality most users travel on existing roads, and most roads have curves. FIG. 8 shows a typical road with two turning points at B-C and D-E. When the mobile user is traveling from A→F, the moving direction (azimuth readings from the digital compass) would help the AP to determine the approximate location of the mobile from the Database Module.

The present disclosure has focused primarily on when the mobile user is on a road that is available from the GIS system. However, it is also possible that the user is in a field trip or moving on a newly constructed road. This scenario may be called random mobility since there exists no road information to follow; and if the AP would reference its database on existing roads, the resultant localization error could be unacceptable.

In this case, the mobile could first inform the AP its random status; then the mobile would walk along a straight path (using the digital compass) and report to the AP three signal strength readings at three distinct positions as well as the distance between them. This way, the AP would search its entire transmission range and identify an optimal fit to the mobile's signal measurements. In order to uniquely locate the mobile, the connected AP may have to query at least another nearby AP using the technique described herein.

In addition, research in radio propagation has been a very active field. Over time, many useful models have been developed to provide the radio path-loss behavior at different conditions. According to some researchers, there are three types of radio propagation models: (1) Outdoor models, (2) Indoor models; and (3) Models for environmental effects. For the near Earth outdoor propagation models, they can again be classified into three categories: foliage models, terrain models, and city models. Compared with the log distance path-loss model used in the present disclosure, most of the above-described models formulate the radio propagation path-loss as a function of distance, radio frequency and other conditions such as the height and gain of the antenna; and they are tailored according to particular terrains, obstruction patterns, or atmospheric conditions. The present disclosure is able to adopt these models with no or only minor changes.

The systems of the present disclosure allow the AP to determine a mobile's location based only on the received signal strength at discrete locations. However, as indicated in FIG. 2, there are four basic configurations of relative positions between the AP and the mobile. Hence, it is very difficult to select the right formula module in location determination. For example, assuming a set of signal strength measurements at three locations P_{A}, P_{B}, P_{C}, and assuming that the signal strength values have the following relationship: P_{A}>P_{B}>P_{C}. According to FIG. 2, the data set could be used in both scenarios of (a) and (c).

However, the dilemma is easily solved. The simplest way is to check other reference APs near the site for a better view of the user's motion. Alternatively, the signal strength monitoring mechanism in the mobile could be explored. In reality, the mobile monitors the received signal strength continuously, therefore, the mobile would easily observe the signal strength characteristics between P_{A} and P_{B}: either the signal strength is monotonously decreasing (FIG. 2(a)), or there exists another maximum reading between them (FIG. 2(c)); and thus the mobile could inform the AP for a correct mathematical module.

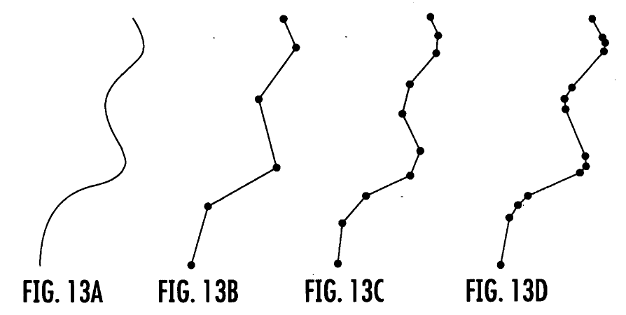

In GIS systems, the vector data model is used to store a collection of related points for a real world road. As indicated in FIG. 13, selecting the appropriate number of points to construct a road could be one of the challenges. In the figure, FIG. (a) is the original road; and FIG. (b)-(d) are three modeling outputs at different resolutions. If too few points are applied, the spatial property would be compromised; on the other hand, if too many points are adopted, unnecessary information would be stored and it would be costly in terms of complexity in data capture, storage, and searching. Much research has been done to optimally select necessary points to represent a line or polyline such that digitized representations are close to the original objects. However, the simplified road representation could obviously affect the matching between the readings of the digital compass and the record in Database of the systems of the present disclosure.

Portable electronic devices have become increasingly more accessible as consumers demand more versatility in a given device. For example, many contemporary mobile phones include not only extensive telephone capabilities, but also calculators, email/instant messaging, cameras, and many other functionalities. It is reasonable that the technology described herein would lead to the demand for inclusion of mechanisms for both direction and speed (or distance traveled) measurements in such devices. With the advance of the MEMS technology (or even a personal network among independent devices), mobile phones will be able to provide various intelligent services in addition to traditional voice communications.

With existing cellular networks and deployment of future networks, the systems of the present disclosure are useful in the development of various projects towards building intelligent transportation systems, such as electronic toll collection, real-time adaptive traffic signals, surveillance, incident detection and response systems, and multi-modal traveler information systems that improves overall traffic operations and reduces congestion. In addition, the system maintenance and data upgrading (such as new road construction or other local emergencies) could be easily updated locally at only one or two APs. Consequently, the systems and methods of the present disclosure would be a convenient complement (or backup) for GPS. It takes advantage of existing communications networks without relying on satellites, and thus saves substantial capital investment from the government.

### System Evaluation

The following examples are meant to illustrate the invention described herein and are not intended to limit the scope of this invention.

### Hardware Components

The prototype system has been evaluated using IEEE 802.11 networks on the University of South Carolina Beaufort campus and in a residential neighborhood. The hardware components used in the experiments included:
1) Accelerometers: dual axis accelerometer with ±5 g per axis from Phidgets, Inc.
2) GPS receiver: NavRoute USB GPS Receiver with WAAS technology and waterproof—HP505. The GPS receiver was used to evaluate the localization performance of the proposed invention.
3) Compass: Daxx military style engineer lensatic digital compass.
4) Laptops: Dell Inspiron 5150 and IBM Thinkpad T60. The Dell ran Fedora core 3 operating systems and was equipped with Orinoco classic gold card. The Thinkpad computer ran XP Home.

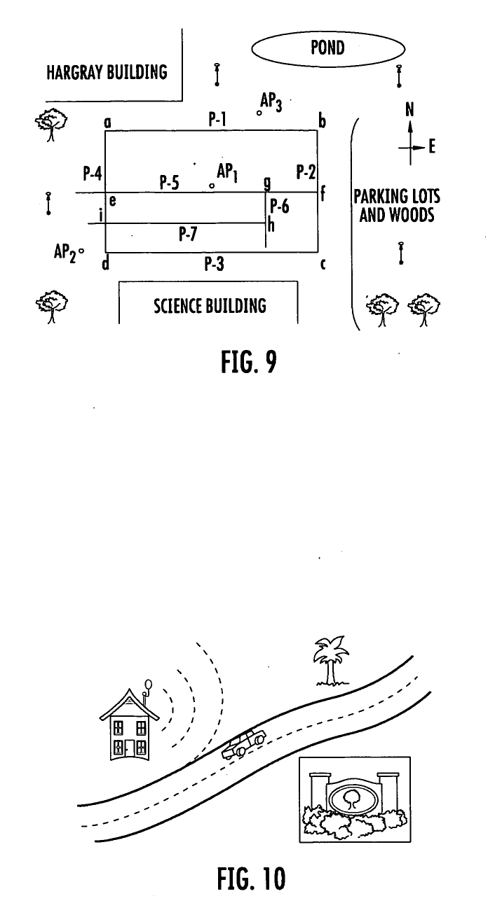

As illustrated in the FIG. 9, the open space testbed of roughly 150 m×250 m between the Hargray building and the Science building has been used for this study. Routes Pᵢ (i=1, 2, . . . , 7) provide seven potential paths for the mobile. Symbols a, b, c, . . . , i mark the transition positions between routes. Three APs were deployed on the site: AP₁ was deployed near the center of the rectangle; AP₂ and AP₃ were deployed at the west and north boundaries respectively. In this experiment, AP1 was used to compute the location of the mobile. Three APs were IBM T60 ThinkPad computers running XP Home; and the mobile was the Dell computer with Orinoco classic gold card running Fedora core 3 operating system.

The experiment was carried out during May and June 2007. Typical weather temperature for most tests was about 33° C. (92° F.), and the humidity was about 60%. As illustrated in FIG. 9 (the open space test-bed at the University of South Carolina Beaufort campus), the mobile moved along the seven routes (P −i, (i=1, 2, . . . , 7)), and at each measurement position, the mobile conducted the following measurements: (1) signal strength received from nearby APs, (2) reference coordinates using GPS, (3) distance traveled between current and previous positions, and (4) direction of motion using the compass. The measured data was transferred to the central AP (AP₁) for localization.

As discussed above, the received signal strength (SS) provides a method of inferring the transmitter-receiver distance. To demonstrate that this is a reasonable assumption, extensive field measurements were conducted using the same hardware and network configurations, and FIG. 11 gives representative results from different environments. In the figure, “Ad hoc-II” (denoted by ‘⋄’) was measured at the USC Beaufort campus (with high temperature and humidity); and the “Infrastructure” (by ‘+’) and “Ad hoc-I” (by ‘x’) were taken in a residential neighborhood with temperature 20° C. (67° F.) and the humidity around 20%.

All measurements present different relationships between the received signal strength and the distance from the transmitter to the receiver, and it is interesting to notice the signal dynamics and the environmental impacts to the wireless communications: 1) because of the high temperature, high humidity, and possibly other parameters like pressure, the effective radio transmission range was much shorter at the USC Beaufort (which is around 30 meters); 2) the measurement results varied every time, and remeasurements along the same route usually would not generate the same signal strength results; and 3) temporary dynamics could render a smaller signal strength value at a shorter distance. Consequently, although signal strength values could be used to roughly indicate the transmitter-receiver distance, a precise notion about the power-distance relationship is quite complex and is beyond the scope of this disclosure. Because of the test-bed environment, all evaluation measurements were limited to within a circle with radius of about 30 meters.

The feasibility of using the accelerometer to measure the speed and the traveling distance has been demonstrated and free code samples for accelerometer are publicly available in various programming languages. For example, Accelerate provides programming code in both Visual Basic and Visual C format along with a detailed description of using an accelerometer to measure the performance of a vehicle. In certain embodiments, sample code from Phidgets Inc. can be modified.

FIG. 12 gives three sample readings at both axes before movement commenced. The readings were recorded when the accelerometer was placed on a desk in three different orientations. In both FIGS. 12(a) and (b), the x-axis represents the number of records in 30 seconds, and the y-axis is the acceleration readings in m/s². FIG. 12 indicates that: (i) both axes of the accelerometer present significant static readings, and the readings are different every time; (ii) the initial static readings are relatively stable; (iii) the reading from the first axis (FIG. 12(a)) is much smaller than that of the second axis (FIG. 12(b)). The results indicate that the accelerometer should be calibrated before every measurement in order to achieve accurate velocity and distance. In addition, in order to measure the traveling velocity and distance, one of the dual measurement units of the accelerometer can be fixed toward the moving direction. However, the adopted accelerometer does not provide detailed instruction on its sensing orientation. Therefore, although the initial results indicated that the speed/distance estimation is feasible by using the adopted accelerometer, a sensor with more detailed documentation could be adopted in future systems.

### Evaluation Results

### Test Results at the University of South Carolina Beaufort Campus:

For all evaluations using the test-bed in FIG. 9, the system obtained an average error ε (Equation 6) of 5.2 m². If the distance dᵢ, (i=1,2,3) and the distance x (the distance between the AP projection on a route and the mobile) were equally weighted in the estimation process, then this error ε would lead to an average localization error of approximately 0.9 meters, or

$$average localization error \approx \sqrt{\frac{ɛ}{3 \times 2}} \qquad ( 7 )$$

The best location error achieved in the experiment was 0.4 meters when the mobile was close to the AP (within 10 meters) while moving on the path P-5. At a greater distance to the AP (beyond 25 meters), the ε went up to 15.2, which would generate a localization error about 1.6 meters. When the mobile is far away from the AP (more than 35 meters depending on the environment), the received signal strength became very weak and unstable, and consequently, the localization performance was not reliable.

### Test Results in a Residential Neighborhood:

A similar experiment was also conducted in a residential neighborhood as illustrated in the FIG. 10. The localization process was slightly different from the previous experiment in that: (1) no knowledge was provided on the AP's exact location within the house; and (2) no knowledge was provided on the reference power for the AP. The limitations demanded advanced searching technology such as Simulated Annealing in the localization process.

The test proceeded as follows: first, the AP (router) was assumed to be in one of the rooms, and therefore, an array of possible values for the do was calculated. Then the computer searched for a potential distance according to the constraints from the received signal strength at different locations.

Similarly, a range of potential values for the reference power was evaluated. By trial-and-error, very respectable results were achieved with this experiment. The best localization error in this experiment was about 0.8 meters; and the average estimation error ε was 7.4, which lead to an average localization error around 1.2 meters when the mobile was close to the house at a distance ranging from 10 to 30 meters.

Test Results using Online Data Resources:

The system was also evaluated using data resources from the PlaceLab research group. The data file used in this evaluation was “downtown1.9.26.04.txt”, and the AP was 00:30:bd:62:73:17; detailed records are copied in Table II.

The “Distance” column in Table II is the distance between neighboring measurement locations calculated from the longitude and latitude coordinates in the 2^{nd} and 3^{rd} columns. For example, 6.313 (2^{th} item in Distance column) is the distance in meters between position 1 and 2. A close look at the table reveals that the coordinates at the 7^{th} and 10^{th} records from the GPS receiver could be wrong.

Note that the signal strength recorded in Placelab is the received signal strength indicator (RSSI), which is different from the SS in this system (in dBm). This means the data cannot be used directly because the translation between these units is hardware dependent. For experimental purposes, a 1:1 scale was used to map the RSSI to SS. Assuming the road is straight, and using the SS in the system, the error ε of 21.1 to 61.6 was achieved. This gives an approximate localization error of 1.9˜3.2 meters.

In the interest conciseness, any ranges of values set forth in this specification are to be construed as written description support for claims reciting any sub-ranges having endpoints which are whole number values within the specified range in question. By way of a hypothetical illustrative example, a disclosure in this specification of a range of 1-5 shall be considered to support claims to any of the following sub-ranges: 1-4; 1-3; 1-2; 2-5; 2-4; 2-3; 3-5; 3-4; and 4-5.

These and other modifications and variations to the present disclosure can be practiced by those of ordinary skill in the art, without departing from the spirit and scope of the present disclosure, which is more particularly set forth in the appended claims. In addition, it should be understood that aspects of the various embodiments can be interchanged both in whole or in part. Furthermore, those of ordinary skill in the art will appreciate that the foregoing description is by way of example only, and is not intended to limit the disclosure as further described in such appended claims.

### Replacement Sheet

TABLE I
ROAD RECORDS AT ONE AP

| | STARTING | | | | | | |
|---|---|---|---|---|---|---|---|
| | LOCATION | | ENDING LOCATION | | | | |
| | LONGI- | | LONGI- | | ATTRIBUTES | | |
| # | TUDE | LATITUDE | TUDE | LATITUDE | α | d₀ | . . . |
| 1 | 80°58′9″ | 32°18′2″ | — | — | — | — | . . . |
| 2 | — | — | — | — | — | — | . . . |
| 3 | . . . | . . . | . . . | . . . | . . . | . . . | . . . |

TABLE II
REFERENCE SIGNAL STRENGTH MEASUREMENT FROM
PLACELAB AP: ID = 00:30:bd:62:73:17

| | | | | DISTANCE |
|---|---|---|---|---|
| # | RSSI | LONGITUDE | LATITUDE | (M) |
| 1 | −68 | −122.33730333333334 | 47.60625000000000 | 0 |
| 2 | −77 | −122.33730666666666 | 47.60630666666666 | 6.3130 |
| 3 | −78 | −122.33736500000000 | 47.60630999999999 | 4.3938 |
| 4 | −88 | −122.33744000000002 | 47.60637333333334 | 9.0217 |
| 5 | −84 | −122.33748666666668 | 47.60648833333333 | 13.2722 |
| 6 | −86 | −122.33759666666668 | 47.60674000000001 | 29.2064 |
| 7 | −89 | −122.33986333333331 | 47.60862999999999 | 270.5619 |
| 8 | −92 | −122.33986000000002 | 47.60864666666660 | 1.8721 |
| 9 | −92 | −122.33991833333334 | 47.60871833333333 | 9.1001 |
| 10 | −93 | −122.34113166666667 | 47.61003000000001 | 172.0811 |

What is claimed is:

1. A system to determine the geographic location of a mobile device comprising:
a mobile device comprising a measurement module, the measurement module being capable of detecting information including the direction and acceleration of the mobile device, the mobile device further being capable of determining the received signal strength from at least one access point; and
at least one access point being in communication with the mobile device, the at least one access point comprising a database module and a location determination module, the database module including data from a geographic information system, the data relating to the potential geographic locations adjacent to the at least one access point, the location determination module being capable of determining the geographic location of the mobile device based on information from the measurement module, received signal strength by the mobile device, and data from the database module.

2. The system of claim 1, wherein the measurement module comprises an accelerometer.

3. The system of claim 1, wherein the measurement module comprises a compass.

4. The system of claim 1, wherein the database module further comprises road geometries and corresponding location attributes.

5. The system of claim 1, wherein the mobile device is a cellular phone.

6. The system of claim 1, wherein the mobile device is a laptop computer.

7. The system of claim 1, wherein the access point is a cellular tower.

8. The system of claim 1, wherein the acceleration of the mobile device is used to determine the speed of the mobile device.

9. The system of claim 1, wherein the data from a geographic information system is vector data.

10. The system of claim 1, wherein the geographic location of the mobile device as determined by the location determination module is capable of being transmitted to the mobile device.

11. A method to determine the geographic location of a mobile device comprising:
utilizing a mobile device and at least one access point to determine the geographic location of the mobile device, the mobile device comprising a measurement module, the measurement module being capable of detecting information including the direction and acceleration of the mobile device, the mobile device further being capable of determining the received signal strength from the at least one access point, the at least one access point being in communication with the mobile device, the at least one access point comprising a database module and a location determination module, the database module including data from a geographic information system, the data relating to the potential geographic locations adjacent to the at least one access point, the location determination module being capable of determining the geographic location of the mobile device based on information from the measurement module, received signal strength by the mobile device, and data from the database module.

12. The method of claim 11, wherein the measurement module comprises an accelerometer.

13. The method of claim 11, wherein the measurement module comprises a compass.

14. The method of claim 11, wherein the database module further comprises road geometries and corresponding location attributes.

15. The method of claim 11, wherein the mobile device is a cellular phone.

16. The method of claim 11, wherein the mobile device is a laptop computer.

17. The method of claim 11, wherein the access point is a cellular tower.

18. The method of claim 11, wherein the acceleration of the mobile device is used to determine the speed of the mobile device.

19. The method of claim 11, wherein the data from a geographic information system is vector data.

20. The method of claim 11, wherein the geographic location of the mobile device as determined by the location determination module is transmitted to the mobile device.
